(19) United States
(12) Patent Application Publication
(10) Pub. No.: US 2008/0300972 A1
(43) Pub. Date: Dec. 4, 2008

(54) SYSTEM AND METHOD FOR GENERATING USER-ASSISTED ADVERTISING RELEVANCY SCORES

(76) Inventor: Jay Pujara, Palo Alto, CA (US)

Correspondence Address: BRINKS HOFER GILSON & LIONE / YAHOO! OVERTURE, P.O. BOX 10395, CHICAGO, IL, 60610, US

(21) Appl. No.: 11/755,571

(22) Filed: May 30, 2007

(51) Int. Cl. G06Q 30/00

(52) U.S. Cl. 705/14

(57) ABSTRACT

Systems and methods for incorporating user feedback on advertising relevancy and providing the feedback to advertisers is disclosed. Generally, a user requests a web page from an online service provider. The online service provider checks to determine if the user requesting the page is a member of the user assisted advertising relevancy user population. If the user is not a member, the online service provider sends the web page the user requested without a method to rate the advertisement. If the user is a member of the user assisted advertising relevancy user base, the online service provider sends the requested web page with the ability to rate the advertisements sent on the page.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Technical Field

The disclosed embodiments relate generally to an advertising relevancy scoring system. More specifically, the disclosed embodiments relate to a system and method for generating user-assisted advertising relevancy scores.

2. Background Information

Online advertising is often an important source of revenue for enterprises engaged in electronic commerce. Online advertising may be used by advertisers to accomplish various business goals, ranging from building brand awareness among potential customers to facilitating online purchases of goods and services. Online advertising, however, differs from traditional forms of advertising because the target of the advertising effort is a user who is actively engaged in the interactive medium in which the advertising content is presented. The medium makes it difficult for advertisers to direct advertisements to individual users that fall, or may potentially fall, within the advertiser's target market. To compensate, advertisers often launch advertising campaigns intended to attract the greatest number of users by employing such methods as broadening their target market, generalizing advertisements to encompass as many users as possible, and expending money to increase the exposure of the advertisements. These efforts, however, are inefficient and can be expensive to implement.

A number of different kinds of page-based online advertisements are currently in use, along with various associated distribution requirements, advertising metrics, and pricing mechanisms. Processes associated with technologies such as Hypertext Markup Language (HTML) and Hypertext Transfer Protocol (HTTP) enable a page to be configured to contain a location for inclusion of an advertisement. The advertisement can be selected dynamically each time the page is requested for display by way of a browser or server application.

Several different types of fee agreements may be made between an advertiser and an online service provider. Often, the fee agreement will be based at least in part on the number of times an ad is displayed and/or viewed. Thus, in order for an advertiser to agree to pay for a particular advertisement, that advertiser would like to know with reasonable certainty the number of times an ad is displayed and viewed. Each display of an ad is referred to as an impression and the number of times an ad is displayed is referred to as the number of impressions for that ad.

Online advertisers also want to measure the effectiveness of their advertisements. Online advertisers want to know which consumers are viewing their online advertisements and which consumers are not. Online advertisers are interested in whether or not consumers find the specific advertisement relevant to the current content the consumer is viewing on the web.

Some methods currently exist that track the number of impressions. For example, many websites may utilize web server logs to measure the number of impressions for an ad. The web server logs include the number of times that a particular website is accessed. However, online advertisements are susceptible to action by robots, spiders, or other monitoring mechanisms which may artificially inflate the number of impressions. A robot or spider may be used to index a particular website, but no advertisement is viewed by a person in this indexing. The advertiser should not have to pay for this automatic access as an impression. Accordingly, advertisers on the Internet want an accurate count of the number of people who view the ad excluding robots, spiders and other non-human activity. In U.S. patent application Ser. No. 11/478,331, filed Jun. 29, 2006 and commonly assigned with the present application, a system and method for measuring online advertising and verification of the accuracy of advertisement impressions are disclosed.

Traditional media, such as television, utilize a ratings system such as that provided by Nielsen Media Research to estimate the number of viewers for a particular show and the advertisements for that show. The Nielsen system gathers viewing data of those who have appropriate equipment installed. Such a system does not currently exist for the Internet.

Additionally, current Internet based tools do not measure the effect an ad has on a user. Nor do they measure the relevance the advertisement has to the web content displayed for that user. Furthermore, current systems do not track the demographics of those who do and do not view their advertisements. A system with the ability to capture a user feedback on the relevance of the advertisement along with demographic data of the user would add significant value for advertisers.

Furthermore, future advertisements sent to all users will change dynamically based on the relevancy data collected. Thus, a method for automatically updating the advertisements displayed on web pages based on collected relevancy data will provide a more targeted forum for advertisers.

### BRIEF SUMMARY

By way of introduction, the embodiments described below include methods and systems for collecting user feedback on the relevancy of advertisements displayed on the way page being viewed.

In a first aspect, a method for incorporating user feedback on advertising relevancy is disclosed. Generally, a user requests a web page from an online service provider. The online service provider checks to determine if the user requesting the page is a member of the user assisted advertising relevancy user population. If the user is not a member, the online service provider sends the web page the user requested without a method to rate the advertisement. If the user is a member of the user assisted advertising relevancy population user base, the online service provider sends the requested web page with the ability to rate the advertisements sent on the page.

In a second aspect, a method for advertisers to opt-into the user assisted relevancy program is disclosed. The online service provider will collect the data transmitted by the user and perform various calculations on the data and aggregate the data. The online service provider will report the relevant aggregated data to advertisers who have opted into the program.

In a third aspect, future advertisements on a web page will be based on feedback data collected from users who have assisted in the advertising relevancy program. All users, even users who are not members of the program, will receive advertisements based on the collected data for the web page they are viewing.

In a fourth aspect, a system for incorporating user feedback on advertising relevancy is disclosed Generally, a user requests a web page from an online service provider. The online service provider checks to determine if the user requesting the page is a member of the user assisted advertising relevancy user population. If the user is not a member, the online service provider sends the web page the user requested without a method to rate the advertisement. If the user is a member of the user assisted advertising relevancy user base, the online service provider sends the requested web page with the ability to rate the advertisements sent on the page.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a simplified view of one embodiment of an operating environment;

FIG. 2 is a simplified view of one embodiment of the prior art;

FIG. 3 is a simplified view of one embodiment of the current invention;

FIG. 4 is a simplified view of a possible configuration of the current invention;

FIG. 5 illustrates portions of a user interface display of a device within the operating environment of FIG. 1;

FIG. 6 is a flowchart illustrating processing of a user web page request in the operating environment of FIG. 1;

FIG. 7 is a flowchart illustrating alternate processing of a user web page request;

FIG. 8 is a flowchart illustrating another alternate processing of a user web page request; and

FIG. 9 is flowchart illustrating a process by which a user becomes part of an advertisement user relevancy program.

### DETAILED DESCRIPTION OF THE DRAWINGS AND THE PRESENTLY PREFERRED EMBODIMENTS

Reference will now be made to the accompanying drawings, which form a part hereof, and which show, by way of illustration, specific exemplary embodiments. The principles described herein may, however, be embodied in many different forms, and this specification should not be construed to limit the claims. Rather, these embodiments are provided so that the disclosure will be thorough and complete to those skilled in the art.

Advertisers and advertising providers would like an accurate measure of the relevancy their advertisement has on the web page being viewed. Furthermore, online service providers and advertisers are interested in the demographics of the users who view or don't view their advertisements, purchase or don't purchase their products, what web sites users go to and a number of other details individual to users. Having access to this information allows advertisers to tailor their online offerings to better attract user interest. Further, being able to provide this information to advertisers allows online service providers to better serve their customers.

The present disclosure is directed to systems and methods for allowing users to provide feedback on which advertisements are most relevant to the content they are viewing. The systems and methods disclosed further allow online service providers to generate various reports based on the collected data to their advertisement partners.

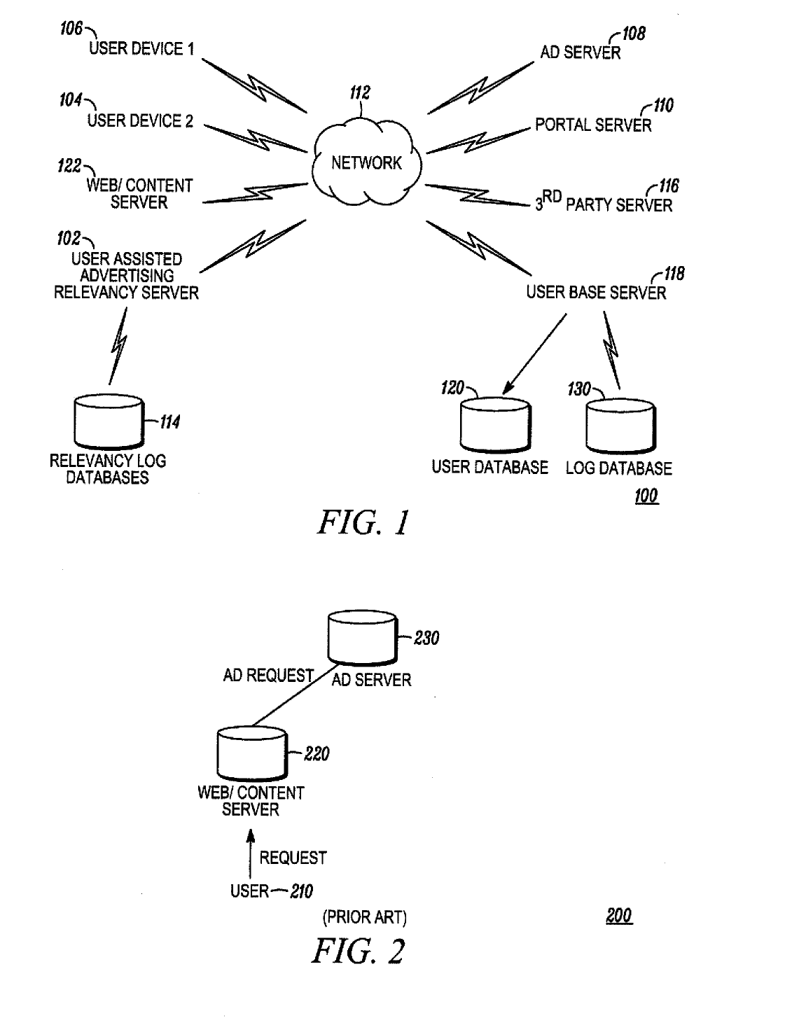

FIG. 1 provides a simplified view of a network environment 100. The environment 100 in the exemplary embodiment of FIG. 1 includes an ad server 108, a portal server 110, a third party server 116, user assisted advertising relevancy server 102, user base ad server 118 and user devices 104,106.

In FIG. 1, the environment 100 includes the ad server 108, which may provide a platform for selection, optimization, and/or distribution of advertisements for inclusion in the user assisted advertising relevancy system. Advertisements used for inclusion in the user relevancy system may be provided by a portal server 110 and/or a third-party server 116. In FIG. 1, clients are represented by user devices 104, 106. In FIG. 1, the user devices 104, 106 are depicted as conventional personal computers. However, any suitable user device may be used, such as a wireless or wireline telephone, a cellular telephone, a personal digital assistant, etc. The user devices are examples of devices used by users who will be rating the advertisements.

Portal server 110, third-party server 116, ad server 108, web/content server 122, user base server 118, user assisted advertising relevancy server 102 and user devices 104 and 106 each represent computing devices of various kinds. Such computing devices may generally include any device that is configured to perform computations and that is capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, user device 104 may be configured to execute a browser application that employs HTTP to request information, such as a web page, from a web server. The illustrated computing devices communicate using a network 112. The network 112 may include any suitable communication network including wire line and wireless networks and may include sub-networks such as local area networks or wide are networks.

A user base server 118 can represent several servers or other devices. The user base server 118 can keep track of all of the user accounts in the host environment's network. In this case, the user base server 118 keeps track of the online service provider user base. The user base server 118 may include a user database that stores data relating to users who are participating or have participated in the user assisted advertising relevancy program. These users will be referred to as members of user assisted advertising relevancy population. Logs of user interactions and transactions relating to the user assisted advertising relevancy program are kept in the user log database 130. Data in the user database 120 and the user log database 130 may be configured on a single database.

A user assisted advertising relevancy server 102 includes software designed and configured to record transactions and perform calculations on the data collected. The user assisted advertising relevancy server 102 may include several databases and application programs to perform such calculations. One such database is the relevancy log database 114. The relevancy log database 114 logs or records each activity related to the relevancy program. Such logging may include the user's id, which web page the user viewed, which advertisement the user rated, what the rating is, and any additional feedback relating to the advertisement and/or the web page the user was viewing at the time the rating took place.

Some or all of ad server 108, portal server 110, and third-party server 112 may be in communication with each other by way of network 112. The ad server 108 and portal server 110 may each represent multiple linked computing devices, and multiple third-party servers. For example, third-party server 116, may be included in environment 100. Network 112 may be regarded as a public or private network connection and may include, for example, a DMZ (demilitarized zone), a virtual private network or an encryption or other security mechanism employed over the public Internet.

User devices 104 and 106 are represented by user-interactive devices that typically run browser applications, and the like, to display requested pages received over a network that include advertisements. The user has agreed and been verified to participate in the user assisted advertising relevancy program.

The components of FIG. 1 represent the many elements that can make up the user assisted advertising relevancy environment. The user assisted advertising relevancy database within user base server 118 and the user log database 130 are linked to the user assisted relevancy server 102. A link between the systems may be configured via proprietary software created for the user assisted relevancy program or standard software packages that can be configured to communicate with other systems and have data relationships with multiple systems.

The user assisted advertising relevancy server 102 may also include reporting software (not shown) that can automatically create reports based on the data captured by the user assisted advertising relevancy server 102. Since the user assisted advertising relevancy server 102 is in communication with many other types of servers, such as ad server 108, user base server 118, etc., it can provide various types of reports based on aggregated data collected by other components in network 112. Such reports will be useful to both online service providers and companies who provide online advertisements. Online advertisers may modify future advertisements based on the user relevancy data collected to better target their user base. Online advertisers may enjoy a more cost effective advertisement approach based on this new system.

Not all of the depicted components in FIG. 1 may be required, however, and some embodiments of the invention may include additional components not shown in FIG. 1. Variations in the arrangement and the type of components may be made without departing from the spirit or scope of the claims as set forth herein. Additional, different or fewer components may be provided.

FIG. 2 is a simplified view of a prior art environment 200. A user 210 requests a web page. The request is sent to the web/content server 220. The content server 220 contacts the ad server 230 with content, layout and captured user information. The ad server 230 returns ads relevant to the content for the appropriate layout position with geo-targeting, behavioral targeting, and demographic targeting.

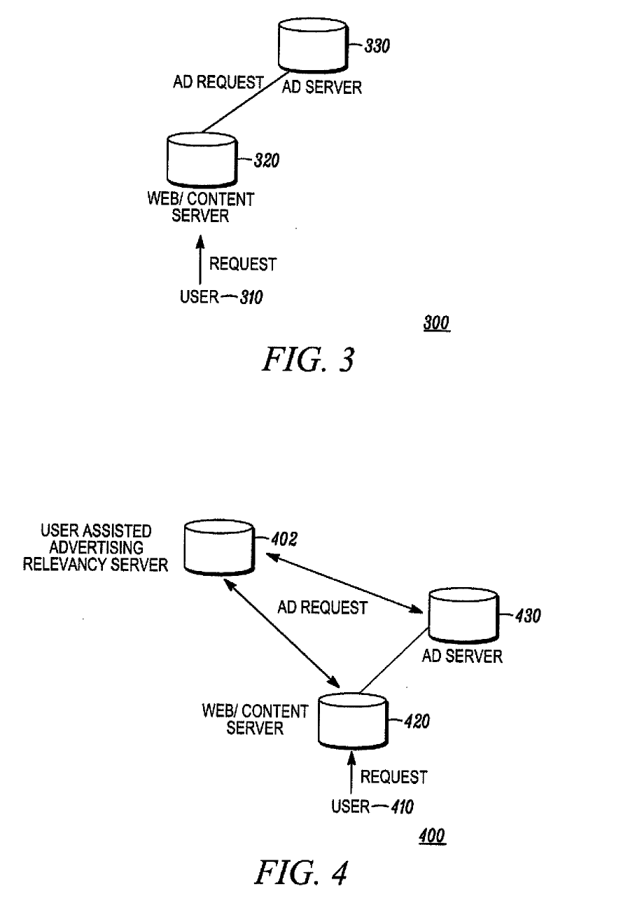

FIG. 3 is a simplified view of a new environment 300 providing unique advantages over the conventional system illustrated, for example, in FIG. 2. In FIG. 3, in one mode of operation, a user 310 requests a web page. The request is sent to the web/content server 320. The content server 320 contacts the ad server 330 with content, layout and captured user information. The ad server 330 returns ads relevant to the content for the appropriate layout position with geo-targeting, behavioral targeting, and demographic targeting. In accordance with the unique features disclosed herein, however, the demographic targeting will be based on the user's demographics and demographic vote information.

FIG. 4 is a simplified view of an alternate environment 400 of the current invention. In one mode of operation of the environment 400, a user 410 requests a web page. The request is sent to the web/content server 420. The content server 420 collects the user information and may check the user assisted advertising relevancy server 402 to determine if relevancy data exists for the web page being viewed. If relevancy data exists for the web page being viewed, the content server 420 collects the data and includes this data when it contacts ad server 430. Alternatively, the web/content server may use the data collected from the user assisted advertising relevancy server 402 to filter the advertisements sent from the ad server 430. In another configuration, the content server may collect user information but not directly contact the user assisted advertising relevancy server 402 for information, but the ad server 430 may use the collected data provided from the content server to find relevant ads from the user assisted advertising relevancy server 402.

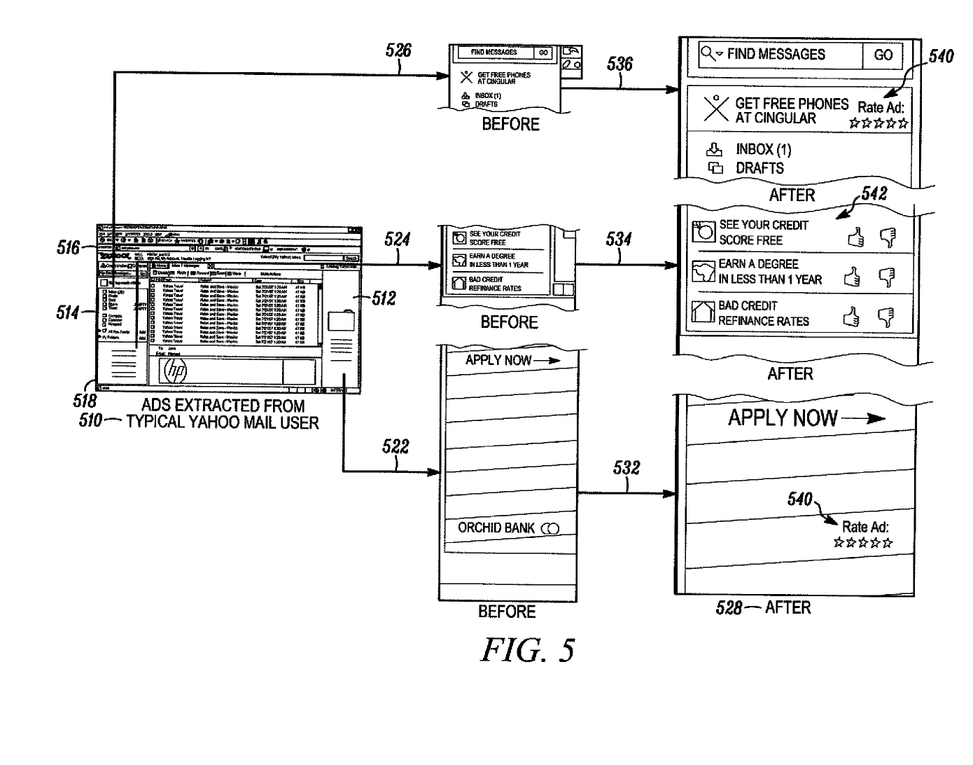

FIG. 5 illustrates portions of a user interface display viewable on a device operating in the environment 100 of FIG. 1. Display 510 represents the typical graphical user interface for an online service provider mail user after the online service provider mail user logs in. Advertisements are displayed in various areas of the screen which show the display 510. Display portion 512, display portion 514, and display portion 516 represent examples of advertisements displayed on the online service provider mail user's screen. Display portions 522, 524, 526 represent exploded views of some of the advertisements within display portions 512, 514, and 516 respectively. The exploded view is meant as a representation of the different areas on a screen where advertisements may appear. Display portions 532, 534, and 536 represent how one embodiment of the current system differs from prior art. In display portions 532 and 536, there is an option for the user to rate the advertisement displayed using a number of stars rating method such as user rating indicator 540. By actuating user rating indicator 542, a user can rate an ad by clicking on the thumbs up or the thumbs down symbol. Clicking on the user rating indicators 540, 542 causes information to be sent to a server about the user's rating of the advertisement.

For example, display portion 522 shows an advertisement in the manner displayed in prior art. The advertisement is displayed and a user has an option to view it or perhaps enter the website of the advertisement. There is no option to rate the advertisement nor is there an option to provide feedback regarding the advertisement. Although an advertiser may be able to determine if their advertisement was clicked, there is no ability for the advertiser to know detailed demographic data about the user clicking their advertisement nor is the advertiser able to ascertain whether the user found the advertisement relevant to the web page being viewed.

Display portion 532 shows the same advertisement with user assisted advertisement relevancy ability. In the display portion 532, a user rating indicator 540 has been added. The user who sees the display portion 532 may use a pointing device such as a mouse to actuate the user rating indicator 540. Upon actuation of the user rating indicator 540, an application will send information representative of the user's selected rating to a server for collection and processing. Users who are members of the user assisted advertisement relevancy population will have the ability to rate advertisements they are viewing. Unlike display portion 522, the user has an option to give a ‘star’ rating to the advertisement in display portion 532. The user can click the number of stars in the user rating indicator 540 to rate the advertisement based on the relevancy the advertisement has on the webpage the user is currently viewing. Users who are not members of the advertising user relevancy population will see the advertisements without the ability to rate the advertisement or provide feedback. These users will view advertisements exactly how they are being viewed in prior art systems such as in display portion 522.

Similarly, the advertisement represented by display portion 524 does not include any means to rate the advertisement or to provide feedback regarding the advertisement. The same advertisement displayed with the new features in display portion 534 includes a method to give thumbs up or thumbs down rating regarding the advertisement.

Once a user rates the advertisement, additional feedback from the user may be captured (not shown). For example, a user may give reasons why this advertisement was not meaningful to the web content the user was displaying. This additional feedback may be captured in numerous ways including multiple choice questions, an area for comments, true/false questions, etc.

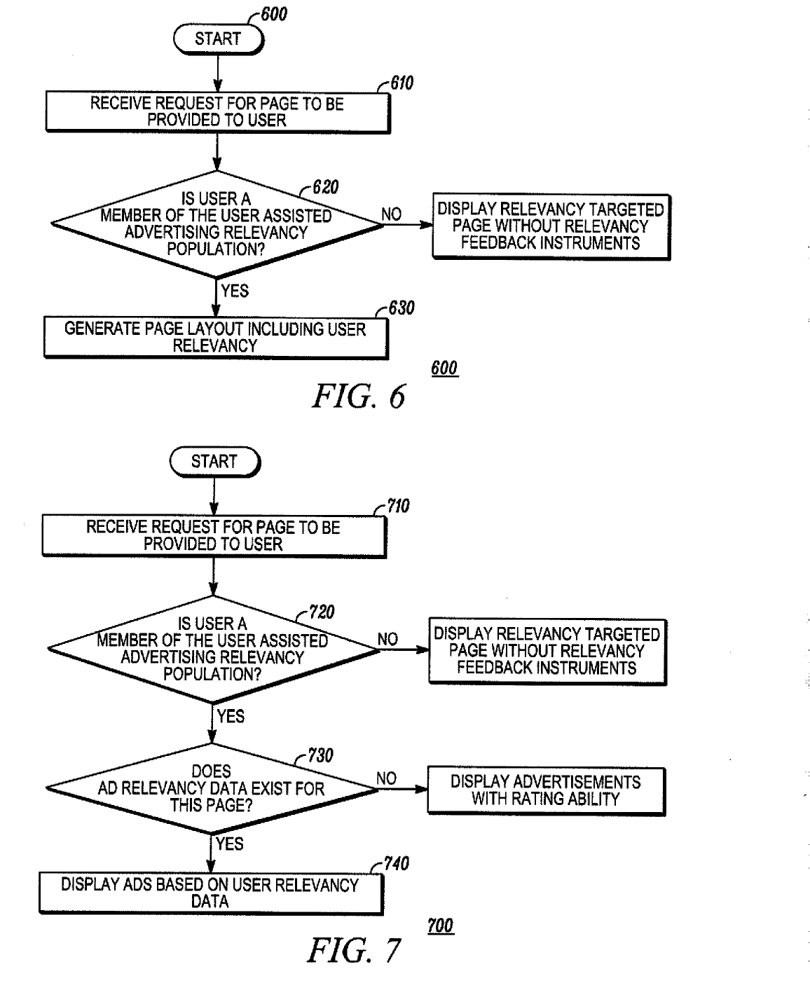

FIG. 6 is a flowchart that identifies the steps undertaken when a user requests a web page. The method begins at block 600. At block 610, a web server or any other server configured to receive a request from a user for a web page, receives a request from a user for a web page. A logged in user is a user who has been authenticated by the online service provider. Thus, a logged in user requests a web page at block 610. Authentication may be obtained using any suitable process, such as requiring the user to enter a preestablished password or by retrieving a cookie or other file from the user's computer or other device.

At block 620, it is determined whether the user is a member of the ad relevancy population. The ad relevancy population consists of those users who have been authenticated by the online service provider to provide ratings and additional feedback on displayed advertisements. If the user is not a member of the ad relevancy population, the web page the user requested is loaded without any advertisement relevancy windows/sections. Advertisements will be displayed in the same manner the prior art in FIG. 5 was displayed. If it is determined that the user is a member of the Ad Relevancy population, web page 630 is displayed. The web page 630 displayed for a user who is a member of the ad relevancy population includes means for the user to rate advertisements.

FIG. 7 is an alternate flowchart that identifies the steps undertaken when a user requests a web page 710. At block 710, a server receives a request form a user for a web page. When a logged in user requests a web page at block 710, a web server receives the request. At block 720, it is determined if the user is a member of the ad relevancy population. If the user is not a member of the ad relevancy population, the web page the user requested is loaded without any advertisement relevancy windows/sections. Advertisements will be displayed in the same or similar manner as in the prior art system illustrated in FIG. 5. The exemplary embodiment of FIG. 7 includes an additional step not included in the example of FIG. 6. At block 730, the system checks to see if Ad Relevancy data is available for the web page requested. It does this by checking the user assisted advertising relevancy server such as server 102 illustrated in FIG. 1 or through an equivalent means. Whether relevancy data exists for the web page being displayed and whether or not the relevancy data is meaningful is checked at block 730. Relevancy data is any data collected by and for the user assisted advertisement relevancy program. For example, if users have provided feedback on advertisements viewed on the current web page, relevancy data would exists for that web page. Whether the data is meaningful can depend on a number of things including the number of collected ratings for a particular advertisement on the web page, the similarity between the ratings collected, or any other criteria set by the web host system.

For example, suppose that W is the web site being requested. In block 730, a database or equivalent storage system in the user assisted advertising relevancy server 102 will be checked to see if any relevancy data for web site W exists. If no relevancy data exists, the web page will be displayed with advertisements and the rating means such as is described above in conjunction with block 630, FIG. 6. If it is determined that advertising relevancy data does exist for web page W, the system will check to see if the data is meaningful. As discussed previously, whether or not data is meaningful can depend on criteria set by the web host system. Furthermore, the step of determining whether the data is meaningful can be performed automatically during step 730 or such data calculations can automatically be performed at given time intervals within the advertising relevancy server. Considerations such as those of the online service provider's needs and the needs of advertisers will determine how and when this data is calculated.

If it is determined that meaningful relevancy data exists, advertisements will be displayed based on the meaningful relevancy data at block 740. Users who are members of the advertising relevancy program will have an opportunity to rate these advertisements. Ideally, the advertisements displayed for a specific web page will ultimately have high relevancy scores.

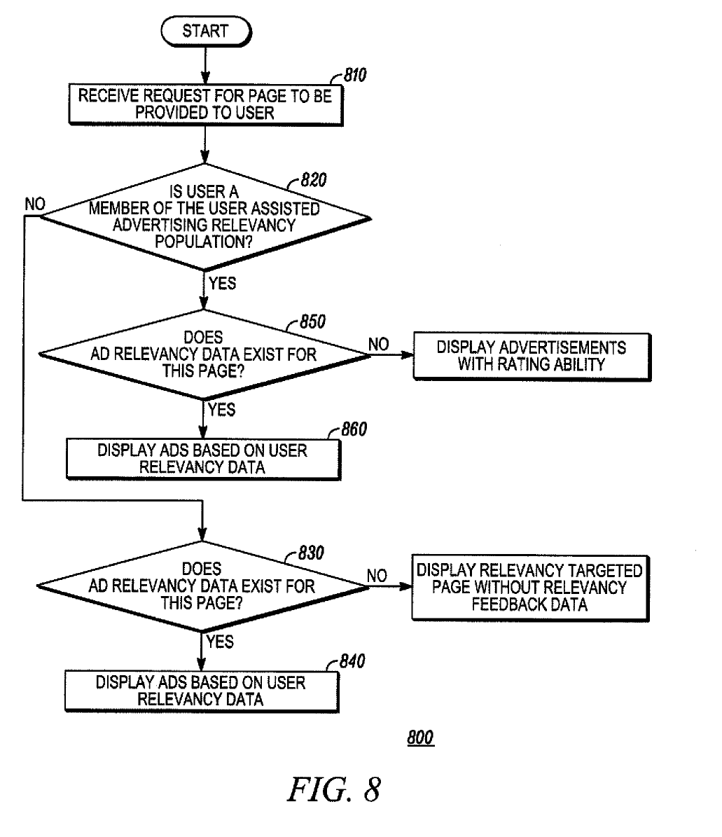

An alternate embodiment of FIG. 7 may also include advertisements based on relevancy scores for users who are not members of the advertising relevancy program as shown in FIG. 8. In this scenario, the users will not have an opportunity to rate the advertisements. However, if meaningful relevancy data exists, the advertisement will be displayed based on the meaningful relevancy data even to those users who are not members of the user assisted relevancy population. A request for a web page is received at block 810. At block 820, it is determined whether the user is a member of the user assisted advertising relevancy population. If the user is not a member of the user assisted advertising relevancy population, it is determined whether meaningful relevancy data exists at block 830. If meaningful relevancy data exists, the ads will be displayed based on the user relevancy data such that even users who are not members of the program will receive advertisements based on the data collected from those who are members of the population. If it is determined at block 850 that meaningful relevancy data does not exist, the advertisements will be displayed in the same manner as prior art. If the user is a member of the user assisted advertising relevancy program, and meaningful relevancy data exists, advertisements will be displayed based on the relevancy data collected. At block 860, users who are members of the program will be able to rate these new advertisements in the same manner they rated previous advertisements.

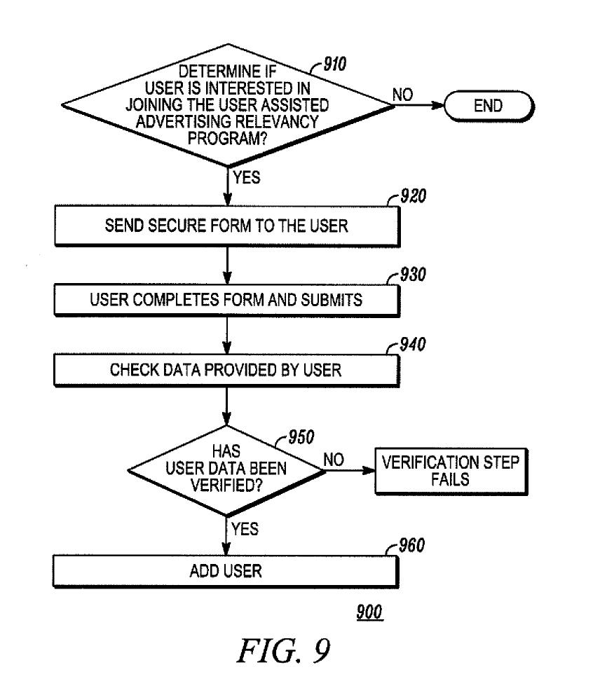

FIG. 9 is flowchart that outlines the steps taken before a user becomes part of an advertisement user relevancy program. In block 910, the system determines whether the user is interested in becoming a member of the advertising relevancy program. This may be done by sending an email to the user outlining the user assisted advertising relevancy program. It may also be done by displaying the web page requested by the user with a pop up window that outlines the program or a number of other methods to inform the user. A response is requested or data is gathered from the user to determine the user's interest.

The information about the program presented to the user may include details about how users will be rewarded for their feedback. For example, a point system may be in place. A user may receive a certain number of points for each advertisement he/she provides a rating for. Once a certain pre-set number of points are reached, the user may redeem exchange accumulated points for gift certificates, movie tickets, online purchases, free samples from advertisers, or anything else of value to the user. Users may be compensated not only on the quantity of their ratings but also the quality of the ratings they provide. For example, an area for additional feedback may be presented to a user. The additional feedback may include specific questions or the option to select advertisements this user would find more useful/relevant to the page he or she is viewing. Users may also be rewarded based on the improvement in advertising relevancy. If the data submitted by a user helps create more improved advertising relevancy, the user may be rewarded.

Once the user response is received by the online service provider, at block 920 a secured form is sent to the user. The user will be required to fill out the form and provide data that can be verified at block 930. For example, the form may include the user's name, address, email, etc. Additionally, demographic data about the user may be collected. Such data can include the user's age, primary industry of employment, percentage of online purchases over the past year, items purchased online over the past year, the amount spent on online purchases over the past year, etc.

The demographic data collected in addition to the advertisement relevancy data gathered will be an invaluable tool for both online service providers and advertisers. Advertisers can base future advertisement campaigns based on data received by past advertisements. Advertisers will also have increased knowledge on their current customers and those customers they would like to target. For example, if the data collected shows that people between the ages of 20 and 30 purchase an alternative product, the advertiser may target some future advertisements to that particular age group. Alternatively, the data collected may show an advertiser why people in that age group do not buy their products and advertisers can make adjustments to their products and campaigns based on that data. Furthermore, online service providers may gain additional revenue by providing detailed reports on the data collected to advertisers.

Additional verification data may also be collected to avoid fraud. In block 940, the user's data is checked for accuracy and fraud prevention. If it is determined that the user is a valid user, the user is added to the user assisted advertisement relevancy population of users, block 960. If it cannot be determined at block 950 that the user has been verified, the verification step fails and the program ends. To further prevent fraud, the system may automatically check for fraudulent activity periodically or with certain ‘triggered’ activity. For example, a trigger may be set in place if a user continuously rates the same advertisement either positively or negatively.

Once the online service provider has collected relevant date, they may choose to include advertisers in the user assisted relevancy program. The online service provider may provide the feedback received on advertisements in return for some fee agreement negotiated with advertising companies. The data collected by the online service provider measures the effect specific advertisements have. The data will also show whether users perceive the advertisement as relevant to the web content they are viewing. Advertising companies will be interested in the data accumulated by the online service provider for their advertisements as well as data collected for competitor advertisements. As previously described, the demographic and detailed data collected can assist advertisers in future advertising campaigns and future products.

The online service provider would ensure that any data given to advertisers will be stripped of any sensitive user data such as name, address, email, etc. The online service provider may provide advertisers with a report that captures the data for that advertiser based on the agreement between the online service provider and the advertiser.

From the foregoing it can be seen that the present invention provides a system that captures user feedback on the relevance an advertisement has to the web page the user is viewing. Furthermore, demographic data about the user will show advertisers who is viewing their advertisements and who finds their advertisements relevant/not relevant to specific web pages. Additionally, future advertisements on a web page will be based in part on relevancy data collected by users. This will improve the ability for advertisers to advertise to their target markets.

It is intended that the foregoing detailed description be understood as an illustration of selected forms that the invention can take and not as a definition of the invention. Accordingly, the invention is not to be restricted except in light of the attached claims and their equivalents.

1. A method for determining user relevancy of an advertisement, the method comprising:
formatting a web page in response to a user request;
wherein formatting includes inserting at least one advertisement in the web page;
including inserting a rating device for the at least one advertisement on a web page;
and
receiving user rating of the advertisement produced by user interaction with the rating device.

2. The method according to claim 1 further comprising providing at least one server for performing calculations based on the received user rating;
wherein performing calculations includes storing the rating.

3. The method according to claim 2 wherein the at least one server collects demographic data from the user prior to authorizing users to rate advertisements.

4. The method according to claim 3 wherein the demographic data includes at least one of age, sex, income, primary industry, and information relating to the user location.

5. The method according to claim 3 wherein the at least one server collecting the demographic data has built in security so a user's personal data is not compromised.

6. The method according to claim 2 wherein the at least one server is a web server that displays future advertisements based on previous user relevancy data collected.

7. The method according to claim 5 further comprising:
a web server log database coupled with the web server;
communicating data related to the at least one advertisement between a web server log database and the web server.

8. The method according to claim 1, wherein inserting a rating device comprises inserting a device to rank an advertisement based on predefined criteria

9. The method according to claim 1 wherein formatting comprises inserting a link near the advertisement where a user can rank the advertisement.

10. The method according to claim 1 wherein receiving the user rating comprises:
receiving data capturing the relevancy of the advertisement.

11. The method according to claim 1, wherein inserting a rating device for the advertisement on the page further comprises inserting a device to provide additional feedback regarding the advertisement.

12. The method according to claim 1 further comprising compensating users for their feedback.

13. The method according to claim 12 wherein compensating users comprises providing compensation based in part on at least one of level and quality of the feedback.

14. The method according to claim 1 wherein receiving user rating of the advertisement produced by user interaction with a rating device comprises preventing fraud.

15. The method according to claim 14 wherein preventing fraud comprises:
performing calculations on data received to determine whether a user consistently rates the same advertisement.

16. The method according to claim 1 wherein formatting a web page in response to a user request further comprises the step of verifying the user has opted to take part in determining user relevancy of an advertisement.

17. A method for advertisers to receive user relevancy data, the method comprising:
collecting user relevancy data;
performing calculations on the user relevancy data;
aggregating the user relevancy data;
reporting the aggregated user relevancy data;
wherein the user relevancy data provides advertisers with feedback relating to their advertisements.

18. The method according to claim 17 further comprising a fee agreement between an online service provider and an advertiser;
wherein the fee agreement depends on the level of feedback provided to the advertiser.

19. The method according to claim 18 wherein the feedback includes data relating to which advertisements were considered relevant or irrelevant to the web page displayed in response to a user request.

20. The method according to claim 18 wherein the feedback includes demographic trends relating to the advertisement.

21. The method according to claim 18 wherein the feedback omits all confidentional data.

22. A method for displaying future advertisements based at least in part from collected relevancy data, the method comprising:
Collecting relevancy data;
Storing relevancy data;
wherein collecting relevancy data comprises:
at least one rating for the web page being displayed.

23. A computer-readable storage medium comprising a set of instructions to direct a computer system to perform acts of:
formatting a web page in response to a user request;
wherein formatting includes inserting at least one advertisement in the web page;
including a rating device for the at least one advertisement on a web page; and
receiving user rating of the advertisement produced by user interaction with the rating device.
